(19) United States
(12) Patent Application Publication
(10) Pub. No.: US 2004/0069704 A1
(43) Pub. Date: Apr. 15, 2004

(54) Filter having holes in filter section thereof

(76) Inventors: Takashi Yamaguchi, Obu-city (JP); Toshiyuki Yoda, Kariya-city (JP); Eiji Itou, Anjo-city (JP); Senta Tojo, Kariya-city (JP)

Correspondence Address: NIXON & VANDERHYE, PC, 1100 N GLEBE ROAD, 8TH FLOOR, ARLINGTON, VA, 22201-4714, US

(21) Appl. No.: 10/622,660

(22) Filed: Jul. 21, 2003

(30) Foreign Application Priority Data
Aug. 8, 2002 (JP) 2002-231555
Feb. 20, 2003 (JP) 2003-43216

(51) Int. Cl. B01D 35/02

(52) U.S. Cl. 210/497.01; 210/498

(57) ABSTRACT

A filter is press-inserted into a mounting bore of an injector. The filter has an inlet section at an opening-end fuel inlet side and a filter section which has a number of holes. The bottom of the filter section is hemispherically-shaped so that a flow area formed between the outer surface of the hemispherical bottom portion and the inner round surface of the mounting inlet bore widens gradually to reduce pressure loss effectively.

### CROSS REFERENCE TO RELATED APPLICATION

This application is based on and incorporates herein by reference Japanese Patent Applications No. 2002-231555 filed on Aug. 8, 2002 and No. 2003-43216 filed on Feb. 20, 2003.

### FIELD OF THE INVENTION

The present invention relates to a filter, which is disposed in a fluid passage, is used for arresting debris contained in a fluid, and relates to a fuel injection apparatus using the filter for an internal combustion engine.

### BACKGROUND OF THE INVENTION

In recent years, to meet emission regulations for diesel engines, diesel fuel is high-pressurized, and electrical control systems are applied to injection systems. With respect to fuel injection apparatuses, conventional automatic valve operation systems have been replaced to electrically controlled nozzle systems with solenoid valves. Demands are increasing for a filter to arrest debris in a fuel to protect the fuel injection apparatus, such as a precise sliding portion, a solenoid valve, and an orifice. A filter is roughly classified into two kinds. One is for arresting debris contained in a fuel normally. The other is for arresting debris generated in manufacturing piping process. The latter is disposed in a high-pressure fuel passage. Therefore, pressure loss has to be low. At the same time, high arresting performance is needed.

In a conventional filter in JP-U-3-6052, debris is arrested at a gap between an outer round surface of a filter and an inner round surface in which the filter is mounted. However, thin debris and needle-shaped debris passes through the gap. On the other hand, if the gap is reduced to enhance arresting performance, pressure loss is increased due to reduction of a flow area.

### SUMMARY OF THE INVENTION

In view of foregoing problems, it is an object of the present invention to provide a filter and a fuel injection apparatus using the filter, which can arrest thin debris and needle-shaped debris, having a sufficient flow area. High arresting performance and low pressure loss are accomplished at the same time.

According to the present invention, a filter is disposed in a fluid passage. The filter is cylindrically-shaped having an inlet section and a filter section. The end section of the filter section is closed. The filter is disposed in a fuel inlet bore in which an opening side is set to be an inlet. Plural small holes are bored as filter holes on a peripheral round surface of the filter section. The closed end section is shaped so that a cross-sectional flow area, which is formed between the outer round surface of the closed end section and the inner round surface of the fuel inlet, widens gradually toward a downstream direction.

A fluid flows from the opening side of the inlet section to the filter section. Then the fluid passes through the plural small holes of the filter section. If each diameter of the small holes is smaller than debris, debris cannot pass through the small holes and are arrested. With respect to the end section of the filter section, no hole is bored. So debris, which is shaped like a fine needle, can be arrested at the end section.

A fluid, which passed the plural small holes, flows through the annular flow area formed between the filter and the fuel inlet toward the down stream direction. The end of the filter section is shaped in an approximately hemisphere or an approximately cone or the like. At the end of the filter section, flow area expands gradually. So vortex flow, which arises due to step increase of a flow area, is suppressed. Thus pressure loss is decreased.

Preferably, the filter section is formed so that the cross sectional area of the annular flow area formed between the filter and the fuel inlet is equivalent to or less than summation of cross-sectional areas of the small holes. Thus, a flow rate passing the filter depends on the annular flow area. That is, the outer diameter of the filter section and the inner diameter of the fuel inlet are dominant factor for the flow rate, regardless of the number of the small holes and manufacturing precision of the small holes. So, flow rate can be regulated precisely, and individual performance of the filter can be in uniform.

It is preferable to form the plural small filter holes such that the diameter of each hole increases toward a downstream side. Thus, vortex flow, which arises due to step increase at the outlet of the small holes, is suppressed. Widening of the outer side of the small hole reduces flow resistance at the outlet. As a result, pressure loss can be decreased. Tapered bore or stepped straight bores are also effective to enlarge flow area gradually toward downstream direction.

Combination of plural shapes such as approximately hemispherical bore, straight bore, and tapered bore can be used to accomplish similar effect to increase flow area toward the downstream. The combination-shape can be formed easily. For example, approximately hemispherical recess is formed by dimpling, subsequently straight bore or tapered bore is bored on the dimpled hemispherical recess. Furthermore, the dimpling hardens metallic crystal structure.

Additionally, the end of the filter section can be formed so that the flow area increases gradually at the end section as described above. In this case, pressure loss, which is caused while a fluid passes through the plural small filter holes and while a fluid passes around the end section, is decreased. Thus, pressure loss can be reduced further.

A fuel injection apparatus, which has the above filter can remove debris included in a fuel without increasing pressure loss, and is effective to protect inner functional parts of the apparatus.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view of an overall part of an injector using a filter according to a first preferred embodiment of the present invention;

FIG. 2 is an enlarged cross-sectional view of the filter according to the first preferred embodiment;

FIG. 3 is an enlarged cross-sectional view of a filter according to a second preferred embodiment of the present invention;

FIG. 4A is an enlarged cross-sectional view of a filter according to a third preferred embodiment of the present invention;

FIG. 4B is an enlarged cross-sectional view illustrating a shape of each small hole of the filter shown in FIG. 4A;

FIG. 4C is an enlarged cross-sectional view illustrating a shape of each small hole of the filter according to the first preferred embodiment;

FIGS. 5A to 5C are enlarged cross-sectional views illustrating a shape of each small hole of a filter according to a fourth, a fifth and a sixth preferred embodiments of the present invention;

FIG. 6 is a perspective view of a filter according to a seventh preferred embodiment of the present invention; and

FIG. 7 is a schematic view of a machining apparatus used to form small holes of the filter.

### DETAILED DESCRIPTION OF PREFERRED EMBODIMENTS

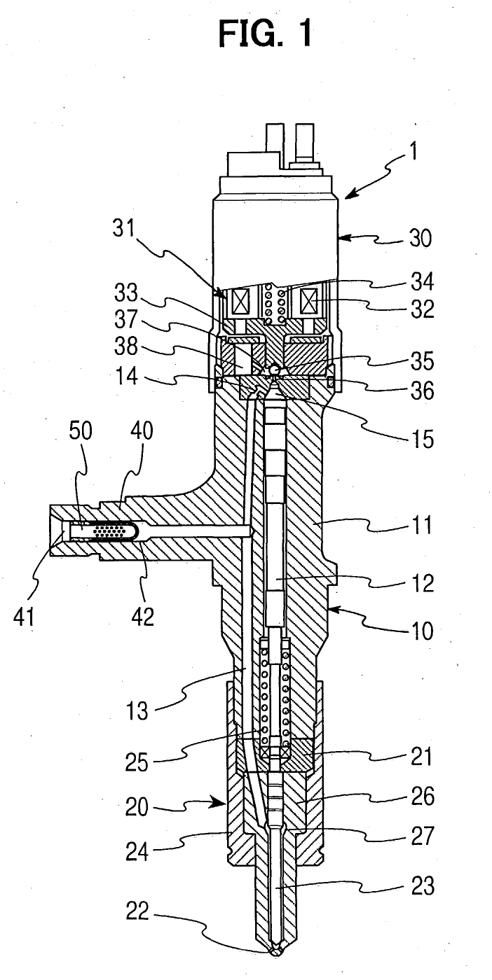

Referring to FIG. 1, a filter according to the present invention is designated by numeral 50 and used in a fuel injection 1 for a common-rail type fuel injection system of a diesel engine. The, injector 1 comprises a body section 10 having a housing 11 and a nozzle section 20 and a solenoid actuator section 30. The injector 1 is disposed at a cylinder head of an engine (not shown) to inject fuel into a corresponding cylinder.

The housing 11 is approximately cylindrically-shaped, and a fuel inlet port 40 protruding from an outer peripheral surface of the housing 11 in a lateral direction is formed integrally as a fuel inlet passage body. A fuel inlet passage 41 is defined inside of the fuel inlet port 40 in which the filter 50 is disposed. The fuel inlet port 40 is connected with a common-rail (not shown).

In the nozzle section 20, a retainer 24 is fixed at the lower end of the housing 11 inserting a tip packing 21 oil-tightly. A nozzle hole 22 is opened around the tip of a nozzle body 26 which is inverted-convex shaped in cross-section. Inside of the nozzle body 26, a needle 23 is accommodated in a vertical hollow connecting to the nozzle hole 22 coaxially. The needle 23 reciprocates in the axial direction, and the tip of the needle 23 separates from a seat (not shown) and sits on the seat. Thus, the nozzle hole 22 is opened and is closed to inject a fuel. Inside of the cylindrical section of the housing 11, a control piston 12 is accommodated on the needle 23 and reciprocates integrally in the longitudinal direction.

A high-pressure fuel passage 13 linking to the fuel inlet passage 41 is defined vertically. A bottom end of the high-pressure fuel passage 13 is led to a fuel accumulator 27 formed around the needle 23 inside of the nozzle section 20. The top end of the high-pressure fuel passage 13 is connected to a pressure governing chamber 15, which is on the control piston 12, via an inlet-orifice 14. When a high-pressurized fuel is fed to the pressure governing chamber 15, the control piston 12 is pressed downward. The needle 23 contacting the control piston 12 is pressed and closes the nozzle hole 22. A first spring 25 is arranged at a bottom of the control piston 12 peripherally to press the needle 23 downward.

A solenoid body 31 fixed above the housing 11 accommodates a solenoid valve to control pressure of the pressure governing chamber 15. The solenoid valve has a solenoid 32 which is connected to an external power source to actuate a “T”-shaped cross-sectional armature 33. The armature 33 is pressed downward, by a second spring 34 and contacts a ball-shaped plug 35 at the bottom end section. The plug 35 opens and closes between a port of an outlet-orifice 36, which is on the top face of the pressure governing chamber 15, and a low-pressure chamber 37 disposed around a bottom end of the armature 33. An upward pressure is applied to the plug 35 from the pressure governing chamber 15 via the outlet-orifice 36.

When the solenoid 32 is energized, the armature 33 is attracted upward releasing a force which pushes the plug 35 downward. The plug 35 is lifted by pressure from the pressure governing chamber 15, and the port of the outlet-orifice 36 is opened. A high-pressurized fuel is exhausted from the pressure governing chamber 15 toward the low-pressure fuel passage 38 via the low-pressure chamber 37. Then, pressure in the pressure governing chamber 15 decreases. A force pressing the needle 23 upward becomes larger than a force pressing the needle 23 downward. Thus, the needle 23 separates from the seat, and a fuel is injected from the nozzle hole 22. When the solenoid 32 is de-energized, the armature 33 is pressed downward by the second spring 34 pressing the plug 35 to close the port of the outlet-orifice 36. Thus, the pressure governing chamber 15 and the low-pressure fuel passage 38 are isolated. Then, pressure of the pressure governing chamber 15 increases. The force which presses the needle 23 downward becomes larger than the force which presses the needle 23 upward, the needle 23 fits on the valve seat, and fuel injection from the nozzle hole 22 is stopped.

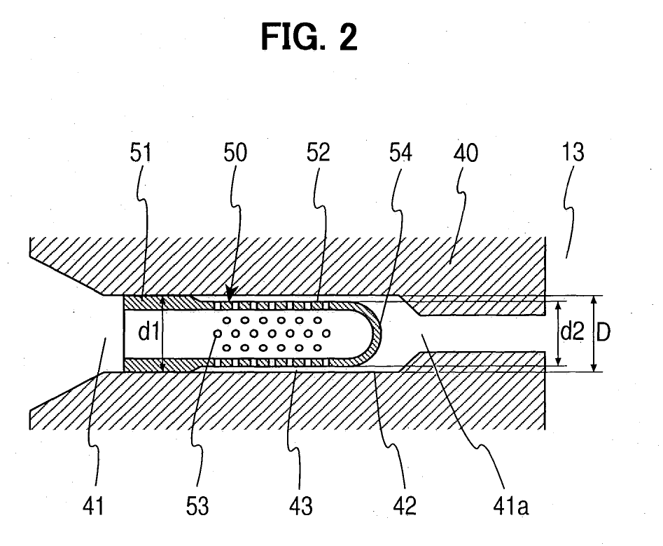

A fuel fed from a common rail flows into the fuel inlet passage 41 shown in FIG.2, and passes an opening end section of the filter 50, an inlet section 51, a filter section 52, and passes through a number of small holes 53 bored in the radial direction in the cylindrical surface.

As shown in FIG. 2, the filter 50 of the first embodiment is hollow cylindrically-shaped, and is closed at the bottom side end. It has the inlet section 51 which has an opening end to be an inlet (left side of FIG. 2), and the filter section 52. The filter 50 is made of metallic material such as a stainless steel and is cold forged. The diameter of the inlet section 51 (outer diameter is d1) is approximately equivalent to or slightly larger than a diameter of the filter mounting bore 42 (inner diameter is D, herein, d1≧D), which is bored at the fuel inlet passage 41. The inlet section 51 is fixed inside the mounting bore 42 by press-insertion or the like. A number of small holes 53 are bored on the cylindrical wall of the filter section 52 (outer diameter is d2; d1>d2) entirely except for an end section 54 which is the closed bottom portion. Inside of the filter 50 is connected to outside through the small holes 53. The diameter of the small holes 53 is designed to be smaller than debris size. Debris floating in a fuel cannot pass through the small holes 53 and is arrested inside of the filter 50. That is, the small holes 53 work as filter holes to arrest the debris which flows into the small holes 53.

Preferably, center points of neighboring three small holes 53 are to be arranged in approximately regular triangle shape. Thus, the number of small holes can be arranged efficiently with keeping strength.

With respect to the end section 54 of the filter section 52, no hole is bored. If debris, which is shaped like a fine needle, flows into the filter section 52, the debris cannot pass through the end section 54, and is arrested.

The end section 54 of the filter section 52 on the closed end side (right side of FIG. 2) is formed so that a cross-sectional flow area formed between the outer peripheral surface of the end section 54 and the inner surface of the fuel inlet port 40 (mounting bore 42) increases gradually toward the closed end side (right side of FIG. 2). In this embodiment, the end section 54 is hemispherically-shaped, so the flow area-does not increase stepwise at the end section 54. Therefore, vortex flow is suppressed. As a result, pressure loss can be decreased. At the same time, depressurization is distributed into the small holes 52 and peripheral of the end section 54, so cavitation is suppressed, and erosion is prevented.

The diameter d2 of the filter section 52 is designed so that the flow area S, which is a cross-sectional area of a annular gap 43 formed between the outer surface of a straight portion of the filter section 52 and the inner surface of the fuel inlet port 40, to be equivalent to or less than a total cross-sectional area Sh, which is summation of cross-sectional areas of the small holes 53. The cross-sectional area S of the annular gap 43 is calculated as followed.

S=π(D/2)²−π(d2/2)²

(D: diameter of the fuel inlet port 40,

d2: outer diameter of the filter section 52)

The D and the d2 are designed so that the cross-sectional area S of the annular gap 43 to be equivalent to or less than the total cross-sectional area Sh of the small holes 53. Then, pressure drop throughout the filter 50 depends on the cross-sectional area S of the annular gap 43. The pressure drop throughout the filter 50 can be regulated precisely by precise manufacturing of the outer diameter d2 of the filter section 52 and the inner diameter D of the fuel inlet port 40. Herein, precise manufacturing of each small hole 53 is not necessarily needed. Thus, performance variation of the injector 1 can be regulated easily.

In the above embodiment, the filter 50 was fixed at the peripheral round surface of the inlet section 51 in the fuel inlet port 40. However, the filter may be fixed with ring-shaped attachment or the like at the fuel inlet port 40.

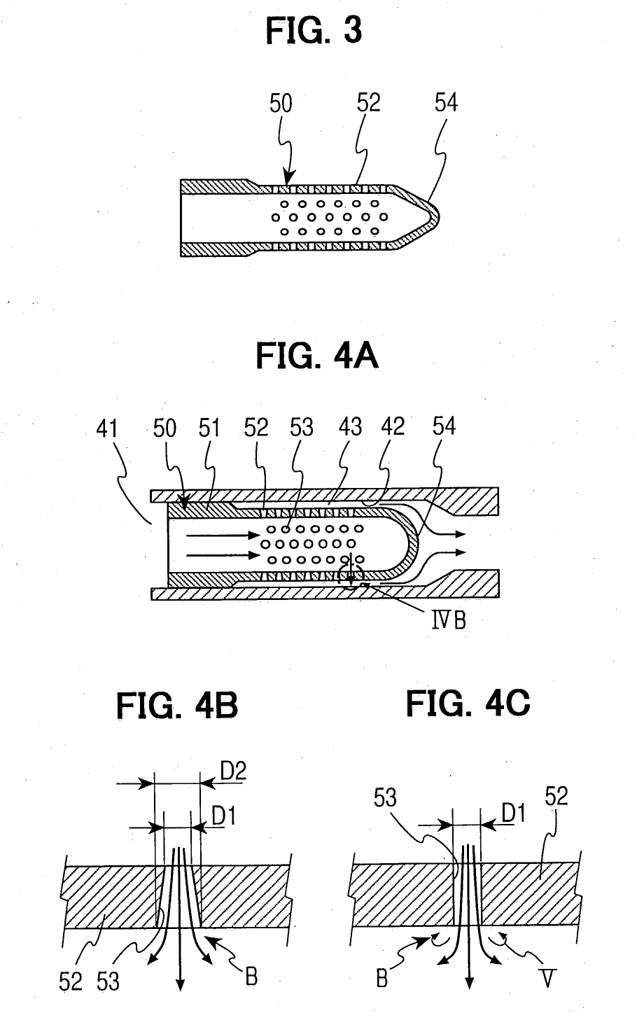

In the second embodiment shown in FIG. 3, the end section 54 of the filter section 52 is conically-shaped. That is, the diameter of the end section 54 is reduced toward the closed end side (right ride of FIG. 3), and an apex of the conical portion is formed approximately hemispherically-shaped. The apex of the conical portion is not necessarily hemispherically-shaped. As far as the cross-sectional area between the outer surface of the end section 54 and the inner surface of the fuel inlet port 40 is formed to have a needed area increasing toward the downstream direction gradually, the end section 54 can be in other shape. Various-shapes, such as an approximately hemispherical-shape, an approximately conical-shape, a curved shape, and combination of a sphere and a cone and a curved surface and so on, can be used.

In the third embodiment shown in FIGS. 4A and 4B, the effect of pressure-loss reduction is improved by a modification of each cross-sectional shape of the small holes 53.

In the above first embodiment (FIG. 4C), each shape of the small holes 53 is formed to be a straight bore in which a diameter D1 is distributed approximately in uniform in a flow direction. Vortex flow V is generated at the outlet B due to stepwise increase of the flow area.

On the other hand, in the third embodiment shown in FIG. 4A, each of the small holes 53 is tapered so that each diameter is widened from the inner surface side to the outer surface side gradually (D2>D1). As a fuel flows toward the outlet B, a flow direction widens out at the outlet B radially. Flow is not apt to peel at the outlet B. The tapered bore structure prevents from generation of vortex flow at the outlet portion B. Thus, pressure loss caused by the vortex flow is prevented.

Generally, a pressure drop in a pipe line is inversely proportional to a flow area, as shown below,

ΔPαL/s (1)

(ΔP: pressure drop, L: length of a piping, s: flow area)

Pressure drop can be decreased by increase of a flow area through the tapered bores.

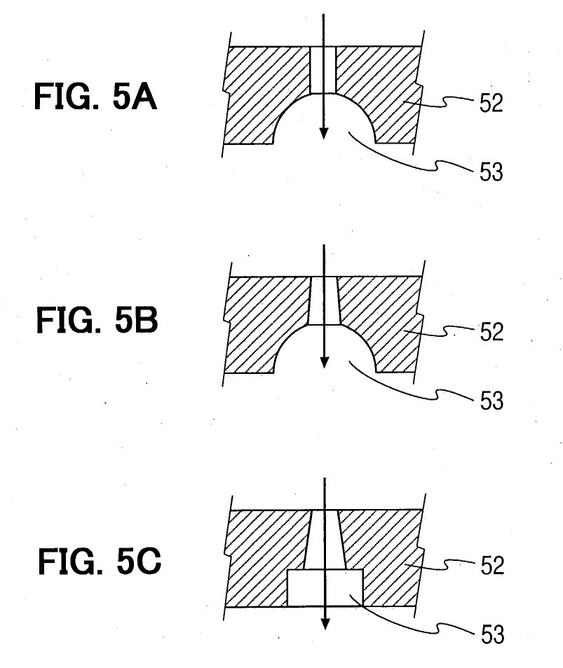

The shape of the small holes 53 is not necessarily tapered. As far as the diameter D2 on the outer round surface of the filter section 52 is larger than the D1 on the inner round surface, the small holes 53 works to reduce pressure loss effectively. Combination of a large diameter straight hole and a small diameter straight hole, or combination of plural bore shapes can be used. Combinations of an approximately hemispherically-shaped bore, a straight bore, and a tapered bore are shown in FIGS. 5A to 5C as the fourth, fifth and sixth embodiments of the present invention. In each embodiment, flow area is increased toward the downstream through the small hole 53. In FIG. 5c, a tapered bore is on an upstream side. However, the tapered bore can be on a downstream side. The combination of the bore shape and bore size are designed to be an optimum combined shape considering utilization condition and shape of the filter and dimension and so on.

The small holes shown in FIGS. 5A and 5B can be formed as follows. At first, approximately hemispherical concave is formed by pressing of an approximately hemispherical tip on the outer round surface (dimpling). Subsequently, straight holes or tapered holes can be bored by laser machining or the like. In this method, boring is performed after a wall thickness is reduced. Thus, boring can be performed easily. Furthermore, a crystal structure is hardened by a cold work. So the hardening is effective to prevent from erosion for high-pressure fluid utility. Not only approximately hemispherical hole, but also a shape shown by FIG. 5C or the like, forming of concaves on the outer round surface by cold work hardens similarly to the above embodiments.

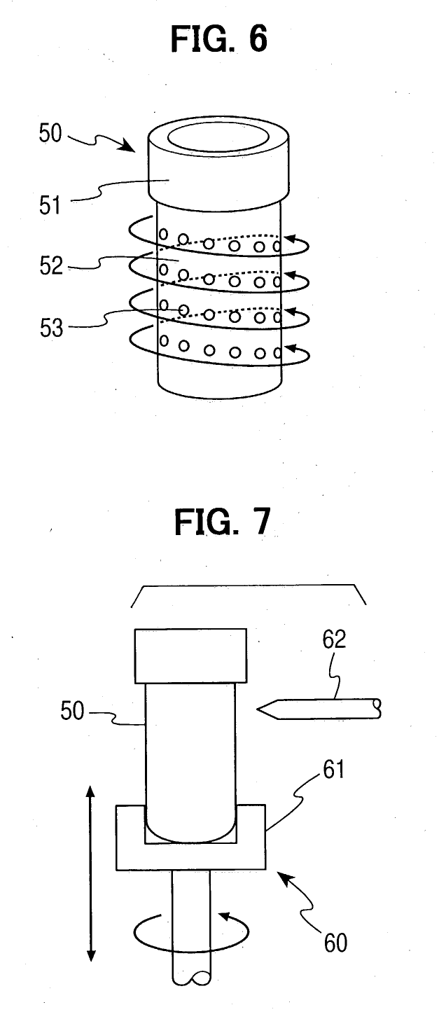

In the above embodiments, the small holes 53 are arranged uniformly on the filter section 52 in a circular direction except for the end section 54. However, as shown in FIG. 6 (seventh embodiment), a number of holes 53 can be arranged helically. For example, small holes 53 are allocated along a helical line at a regular interval. The helical line:displaces in an axial direction at a constant rate on the round surface.

With respect to the structure, for example, continuous boring can be performed with a laser machining apparatus 60 by a simple program, and machining time can be reduced. In detail, the laser machining apparatus 60 comprises a boring tool 62 and a filter holder 61. The filter holder 61 rotates the filter 50 in a designated revolution speed and displaces the filter 50 in a designated speed in an axial direction.

The small holes 53 can be bored from upstream side to downstream side continuously and quickly. At the same time, center points of neighboring three small holes 53 can be arranged in approximately regular triangle shape by adjustment of an axial direction pitch and a rotary direction pitch. Thus, a number of small holes can be arranged efficiently with keeping strength, the filter 50 has a high durability and a low pressure loss property.

Laser machining method is preferable to bore the small holes 53. In this method, the small holes 53 can be bored in a desired cross-sectional shape by adjusting a machining energy to be appropriate amount (around minimum amount for penetration), and a machining time can be shortened. Drilling and electric discharge machining or the like, other machining methods can be applied for machining of the small holes 53.

The filter according to the above embodiments may be used not only in fuel supply systems for engines but also in other fluid supply systems.

What is claimed is:

1. A filter for fitting in a bore of a fluid passage body having an inner surface, comprising:
an inlet section which is fixed in the bore of the fluid passage body at a peripheral surface thereof;
a filter section integral with the inlet section and having a plurality of holes to filter the fluid at a peripheral surface thereof which defines a tubular fluid passage with the inner surface of the fluid passage body; and
a closed end section integral with the filter section, wherein the closed end section is shaped so that a cross-sectional area between an outer surface of the closed end section and the inner surface of the fluid passage body increases gradually in a fluid flow direction.

2. A filter according to claim 1, wherein the closed end section is approximately hemispherically-shaped, so that a diameter of the closed end section is decreased toward the fluid flow direction.

3. A filter according to claim 1, wherein the closed end section is approximately conically-shaped, so that a diameter of the closed end section is decreased toward the, fluid flow direction.

4. A filter for fitting in a bore of a fluid passage body, which has an inner surface defining a fluid passage, comprising:
an inlet section fixed in the bore of the fluid passage body at a peripheral surface thereof;
a filter section integral with the inlet section and having a plurality of holes to filter the fluid at a peripheral surface thereof which defines a tubular fluid passage with the inner surface of the fluid passage body; and
a closed end section integral with the filter section,
wherein each of the holes is formed so that a diameter thereof is larger at a radially outer side of the filter section than at a radially inner side of the filter section.

5. A filter according to claim 4, wherein each of the plurality of holes is tapered to have the diameter gradually increasing toward the outer side of the filter section.

6. A filter according to claim 4, wherein each of the plurality of holes is stepped to have the diameter gradually increasing toward the outer side of the filter section.

7. A filter according to claim 4, wherein the plurality of holes is shaped in different shapes.

8. A filter according to claim 4, wherein the plurality of holes is shaped in two shapes among an approximate hemisphere, a straight bore and a tapered bore.

9. A filter according to claim 4, wherein the closed end section is shaped so that a cross-sectional area between an outer surface of the closed end section and the inner surface of the fluid passage body increases gradually in a fluid flow direction.

10. A filter for fitting in a bore of a fluid passage body, which has an inner surface defining a fluid passage, comprising:
an inlet section fixed in the bore of the fluid passage body at a peripheral surface thereof;
a filter section integral with the inlet section and having a plurality of holes to filter the fluid at a peripheral surface which defines a fluid passage with the inner surface of the fluid passage body; and
a closed end section integral with the filter section, wherein the closed end section has no hole to disable flow of the fluid in an axial direction.

11. A filter for fitting in a bore of a fluid passage body, which has an inner surface, comprising:
an inlet section fixed in the bore of the fluid passage body at a peripheral'surface thereof;
a filter section integral with the inlet section and having a plurality of holes to filter the fluid at a peripheral surface which defines a tubular fluid passage with the inner surface of the fluid passage body; and
a closed end section integral with the filter section,
wherein the tubular fluid passage has a cross-sectional area which is equivalent to or smaller than a summation of cross-sectional areas of the holes at the peripheral surface of the filter section.
